(19) United States
(12) Patent Application Publication
(10) Pub. No.: US 2015/0035982 A1
(43) Pub. Date: Feb. 5, 2015

(54) IMAGE CAPTURING DEVICE FOR A VEHICLE

(71) Applicants: Volker Roelke, Leonberg (DE); Tobias Strauss, Karlsruhe (DE)

(72) Inventors: Volker Roelke, Leonberg (DE); Tobias Strauss, Karlsruhe (DE)

(21) Appl. No.: 14/345,374

(22) PCT Filed: Aug. 6, 2012
(86) PCT No.: PCT/EP2012/065334

§ 371 Date: Oct. 17, 2014

(30) Foreign Application Priority Data
Sep. 22, 2011 (DE) 10 2011 083 232.7

(51) Int. Cl. B60R 1/00; B60R 1/08

(52) U.S. Cl. CPC B60R 1/00; B60R 1/081; B60R 2300/105; B60R 2300/202; B60R 2300/304; B60R 2300/8026; B60R 2300/8046; B60R 2300/804
USPC 348/148

(57) ABSTRACT

An image capturing device for a vehicle includes: a first image capturing apparatus configured to image a surrounding environment of the vehicle, situated outside a window of the vehicle, through a first region of the window, in a first image; and a second image capturing apparatus configured to image a second region of the window in a second image, the first region and the second region overlapping at least partly.

### BACKGROUND OF THE INVENTION

The present invention relates to an image capturing device for a vehicle.

The windshield wipers of a vehicle can be controlled automatically using a rain sensor. Here, a video-based rain sensor system can be used.

DE 102011077703 addresses image capturing in a vehicle.

### DISCLOSURE OF THE INVENTION

Against this background, the present invention presents an image capturing device for a vehicle as recited in the main claim. Advantageous embodiments result from the subclaims and from the following description.

In a video sensor system of a vehicle, for example a video-based rain sensor system, a camera can be used having different image regions. In an image region, also referred to in the following as the secondary image, the windshield of the vehicle can be imaged sharply. In a further image region, also referred to in the following as the primary image, the scene in front of the vehicle can be sharply imaged, in particular the roadway and, in addition or alternatively, vehicles traveling in front, as well as traffic signs.

The sharply imaged region of the windshield can be used to monitor and improve the image of the scene in front of, next to, or behind the vehicle, as well as functions based thereon, such as night vision systems, lane recognition, or approach enable.

In order to secure a correct operation of video-based driver assistance systems, blind spot or unobstructed view monitoring is advantageous, and may be an active component of the function, e.g. in the case of an approach enable function. In addition, the monitoring of a possible blind spot or of a general impairment of a video sensor and video signal due to disturbances in the optical path is relevant for meeting safety requirements and standards.

If the sharply imaged region of the window overlaps completely or partly with the footprint of the optical path that images the scene in front of the vehicle, an item of information determined from the sharply imaged region of the window can be used to support the evaluation of the scene in front of the vehicle. Here, the footprint represents the intersection of the window with the optical path. Through an evaluation of the overlapping image region, an increase in the functional performance, and a self-monitoring, can be realized.

The present invention creates an image capturing device for a vehicle having the following features:

a first image capturing apparatus that is fashioned to image a surrounding environment of the vehicle, situated outside a window of the vehicle, through a first region of the window; and

a second image capturing apparatus that is fashioned to image a second region of the window in a second image, the first region and the second region overlapping at least partly in the footprint on the window.

The vehicle can be for example a passenger vehicle or a truck. The image capturing apparatus can include a camera. The image capturing apparatus can be used as, inter alia, a rain sensor. The image capturing apparatus can be situated inside the vehicle, for example adjacent to a windshield of the vehicle. Thus, the window can be the windshield. Alternatively, the window can be some other window of the vehicle, for example a rear window or side window. Light passing through the first region of the window from the surrounding environment of the vehicle can be captured by the first image capturing apparatus. For this purpose, the first image capturing apparatus can have an image sensor. The first surrounding environment can include a region situated in the direction of travel in front of the vehicle. Thus, the first image can for example represent the roadway, a vehicle traveling in front, or a traffic sign. An item of image information obtained through an evaluation of the first image can be used for example for a driver assistance system. The second image capturing apparatus can have a separate image sensor, or can also use an image sensor used by the first image capturing device.

The second image capturing apparatus can be fashioned to sharply image a surface of the window in the second image. The second region can overlap partly or completely with the first region. Thus, the second region can be included in the first region. The first image capturing apparatus can be fashioned to produce a multiplicity of first images in temporal succession. The second image capturing apparatus can be fashioned to produce a multiplicity of second images in temporal succession.

The first image capturing apparatus can be fashioned to produce an unsharp image of the first region of the window in the first image. The second image capturing apparatus can be fashioned to sharply image the second region of the window in the second image. For this purpose, the first image capturing apparatus and the second image capturing apparatus can have different focal distances. Thus, one and the same segment of the surrounding environment of the vehicle can be imaged sharply in the first image and imaged unsharply in the second image.

According to a specific embodiment, the first image capturing apparatus and the second image capturing apparatus can have a common image sensor for producing the first image and the second image. Different regions of the image sensor can be assigned to the image capturing apparatuses. In this way, the image capturing device can have a very compact construction.

The image capturing device can have one or more optical elements such as lenses or mirrors for deflecting and/or refocusing a first beam of the light that is to be captured by the first image capturing apparatus in order to image the surrounding environment, or for deflection and/or refocusing a second beam of the light that is to be captured by the second image capturing apparatus in order to image the second region of the window. The optical element can be realized as an attachment lens. Through the optical element, the first or second beam can for example be deflected in such a way that the first and the second beam run in parallel, or almost parallel, in the region of the image sensor. It is also possible for both the first and the second beam to be guided through the optical element.

The image capturing device can for example include a mirror, a first lens, and a second lens. Here, the first beam can be guided through the first lens to the first image capturing apparatus, and the second beam can be guided via the mirror, the second lens, and the first lens to the second image capturing apparatus. The second lens can be an attachment lens that can be situated immediately in front of the first lens.

The image capturing device can have an evaluation device. The evaluation device can be fashioned to evaluate the first image and, additionally or alternatively, the second image. The evaluation device can be understood as an electrical device that processes sensor signals and, as a function thereof, outputs control signals or data signals. The device can have an interface that can be realized as hardware and/or as software. In the case of a hardware realization, the interfaces can for example be part of a so-called system ASIC that contains a wide range of functions of the device. However, it is also possible for the interfaces to be separate integrated circuits, or to be made up at least partly of discrete components. In the case of a software realization, the interfaces can be software modules that are present for example on a microcontroller alongside other software modules.

According to a specific embodiment, the evaluation device can be fashioned to recognize, based on the second image, an impairment of view relating to the second region of the window. For this purpose, the evaluation device can be fashioned to evaluate the second image using a suitable image evaluation. The evaluation device can also be fashioned to compare at least two second images captured at different times to one another in order to recognize the impairment of view.

For example, the evaluation device can be fashioned to recognize, based on the impairment of view, a blind spot of the image capturing device. In addition or alternatively, the evaluation device can be fashioned to recognize an impurity of the second region of the window.

The impurity may have been caused by damage or dirt or wetting of the window.

The evaluation device can be fashioned to evaluate the first image taking into account the impairment of view. In this way, disturbing influences in the first image caused by the impairment of view can be recognized and, in some circumstances, eliminated or at least reduced. In this way, the quality of the image information contained in the first image can be improved.

The evaluation device can be fashioned to determine a segment of the first image associated with the impairment of view. The evaluation device can in addition be fashioned to evaluate the first image while suppressing an item of image information of the associated segment. For example, the associated segment can be left out during the evaluation of the first image, or can be reconstructed using the information concerning the type, position, and/or form of impairment, and/or using image information concerning adjacent segments.

According to a specific embodiment, the evaluation device can be fashioned to recognize, based on the first image, a blind spot of the image capturing device, and, in addition or alternatively, an impurity of the first region of the window. Recognition of the blind spot or of an impurity is important in order to avoid malfunctioning of driver assistance systems that use image information included in the first image to perform an assistance task.

In the following, the present invention is explained in more detail in relation to examples based on the accompanying drawings.

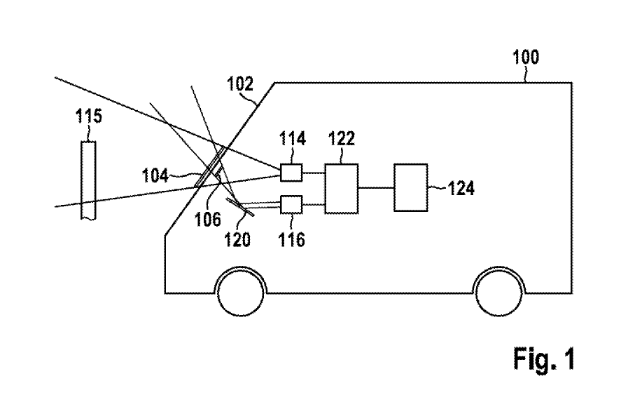

FIG. 1 shows a schematic representation of a vehicle having an image capturing device according to an exemplary embodiment of the present invention;

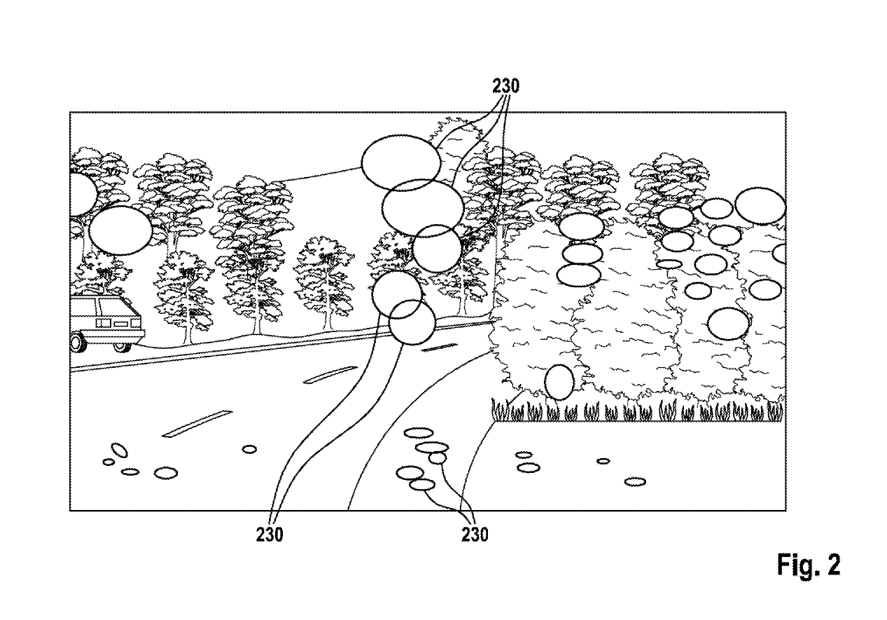

FIG. 2 shows an image of a surrounding environment of the vehicle; and

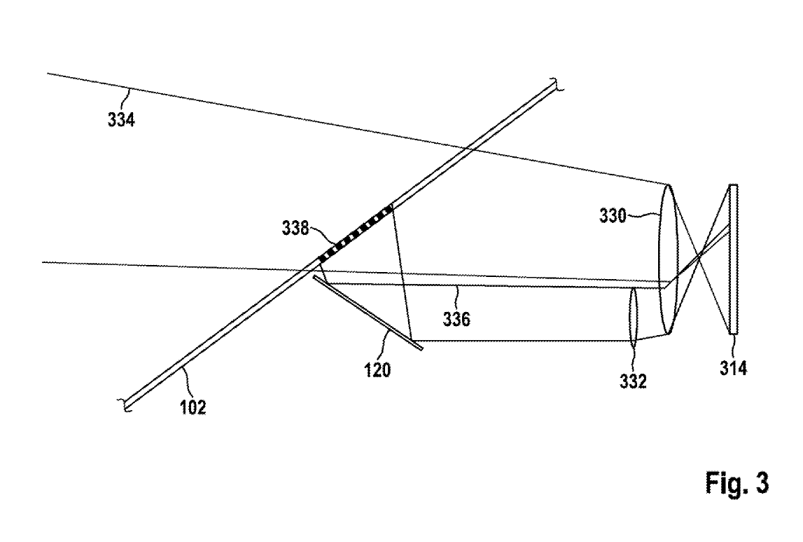

FIG. 3 shows a schematic representation of an image capturing device according to an exemplary embodiment of the present invention.

In the following description of preferred exemplary embodiments of the present invention, identical or similar reference characters are used for elements shown in the various Figures that have similar functions, and repeated description of these elements is omitted.

FIG. 1 shows a schematic representation of a vehicle 100 having an image capturing device according to an exemplary embodiment of the present invention. The image capturing device is situated in the interior of vehicle 100, behind a windshield 102 of vehicle 100. The image capturing device is fashioned to capture, through a first region 104 of windshield 102, a surrounding environment of vehicle 100 situated outside a window of vehicle 100. In addition, the image capturing device is fashioned to capture a second region 106 of windshield 102. For this purpose, the image capturing device has a first image capturing apparatus 114 that is fashioned to image the surrounding environment, for example an object 115 situated in front of vehicle 100, in a first image, the so-called primary image. In the first image, in addition first region 104 of window 102 is imaged unsharply. First image capturing apparatus 114 is fashioned to sharply represent the surrounding environment, for example object 115, in the first image. In addition, the image capturing device has a second image capturing apparatus 116 that is fashioned to sharply represent second region 106 of windshield 102 in a second image, the so-called secondary image.

According to this exemplary embodiment, the image capturing device has a lens 120 that is fashioned to deflect a beam of second image capturing apparatus 116 so that second image capturing apparatus 116 can image second region 106 of windshield 102.

First image capturing apparatus 114 is fashioned to output a produced first image, for example in the form of a digital image, to an evaluation device 122. Corresponding thereto, second image capturing apparatus 116 is fashioned to output a produced second image, for example in the form of a further digital image, to evaluation device 122. Evaluation device 122 is fashioned to evaluate both the first image and the second image, for example using object recognition or pattern recognition. For example, evaluation device 122 can be fashioned to recognize, based on the images, raindrops on windshield 102, or, using object recognition, to recognize objects 115 in the surrounding environment of vehicle 100. Evaluation device 122 can be fashioned to combine information determined from the first and the second image, or for example to use information determined from the second image for the evaluation of the second image. According to this exemplary embodiment, evaluation device 122 is fashioned to output evaluated image information relating to the first image, the second image, or both images, to a driver assistance system 124 that performs a driver assistance task based on the evaluated image information. Driver assistance system 124 can for example include a rain sensor functionality, lane assist functionality, or distance functionality, based on the evaluated image information.

FIG. 2 shows an image of a surrounding environment of a vehicle according to an exemplary embodiment of the present invention. The image can for example be the second image captured by second image capturing apparatus 116 shown in FIG. 1. In the image, the surrounding environment is represented sharply. Impurities 230 on the window of the vehicle, such as raindrops, are in contrast shown unsharply. The impurities 230 make an evaluation of the image more difficult, because segments of the surrounding environment are covered by impurities 230, or are blurred. In order to evaluate the image, first, as is described for example on the basis of FIG. 1, a further image can be evaluated, in which the window and thus also impurities 230 are shown sharply. From the further image, for example a position and size of impurity 230 can be determined. The information obtained from the further image regarding impurities 230 can then be taken into account in the evaluation of the image shown in FIG. 2. Thus, for example segments of the image shown in FIG. 2 that contain impurities can be suppressed during the evaluation, or can be reconstructed based on adjacent image information.

FIG. 3 shows a schematic representation of an image capturing device according to an exemplary embodiment of the present invention. The image capturing device has an imager 314, a lens 330 for the primary image, an attachment lens 332 for refocusing, and a mirror 120. The image capturing device is situated adjacent to a windshield 102. Depicted is a cone of vision 334 of the primary region. Light included in vision cone 334 passes through windshield 102 and is imaged by lens 330 onto a first region of imager 314. In addition, a vision cone 336 of the secondary region is shown. Light included by vision cone 336 is deflected by mirror 120 onto attachment lens 332, starting from a region of windshield 102 that is situated within the region of windshield 102 included by vision cone 334, thus representing an overlapping 338 of the footprint of the primary region and of the secondary region. Attachment lens 332 is situated adjacent to lens 330. Light passing through attachment lens 332 is then imaged by lens 330 onto a second region of imager 314. Through attachment lens 332, the light included by vision cone 336 of the secondary region can be refocused in such a way that the region of windshield 102 included by vision cone 336 can be sharply imaged by imager 314. In contrast, the region of windshield 102 included by vision cone 334 of the primary region is unsharply imaged by imager 314.

According to this exemplary embodiment, an image capturing apparatus for the primary region and an image capturing apparatus for the secondary region are united in the one imager 314. The second region of imager 314, assigned to the secondary region, is situated adjacent to the first region of the imager, which is assigned to the primary region. Imager 314 thus has two non-overlapping regions for the primary region and for the secondary region.

In the following, exemplary embodiments of the present invention are described in summary on the basis of FIGS. 1 through 3.

According to an exemplary embodiment, the sharply imaged region of windshield 102 in the secondary image is selected, through suitable optical elements 106, in such a way that it agrees at least partly with the intersection of windshield 102 and the vision cone of the primary image. In this way, it is thus possible to observe and evaluate, in the secondary image, the region of windshield 102 that is relevant for the primary image. Here, through the sharp imaging in the secondary image more information, or different information, can be determined than in the primary image, because objects 230 such as dirt or water on windshield 102 are shown only in blurred fashion in the primary image, and, under some circumstances, cannot even be recognized as objects 230, although they will very probably disturb the image capturing and obtaining of information.

Using the information gained from the monitoring, for example a blind spot or even merely partial disturbance due to dirt, water, snow, or ice, can be recognized. In addition, the information can be used to improve functions that are also based on the primary image. Such functions are described in general in FIG. 1 as driver assistance system 124. In this context, examples include a blind spot recognition in the primary image, an unobstructed view recognition e.g. for an approach enable, a suppression of disturbed regions and image reconstruction for other image-processing functions, but also for displaying systems such as a night view system.

According to an exemplary embodiment, there is a realization of an optical system of an image capturing device having at least two different focal distances and at least two sensitive surfaces on at least one imager, wherein the areas of intersection of the vision cone with windshield 102 overlap entirely or partly.

The information acquired by the at least one imager or image sensor can be used to carry out at least one of the tasks described below, for example of a driver assistance system 124. In particular, a monitoring and/or localization of dirt on a window, a quantity of rain, or a quantity of snow can be carried out.

A monitoring and/or localization of the window contamination can for example be used to activate the washing equipment, for blind spot recognition, for unobstructed view recognition, for the suppression of covered, disturbed, or blurred regions for further image-based functions, or for image reconstruction of covered, disturbed, or blurred regions for further image-based functions.

A monitoring and/or localization of the quantity of rain or quantity of snow can be used for blind spot recognition, for unobstructed view recognition, for the suppression of covered, disturbed, or blurred regions for further image-based functions, or for image reconstruction of covered, disturbed, or blurred regions for further image-based functions.

The exemplary embodiments described and shown in the Figures are selected only as examples. Various exemplary embodiments can be combined with one another completely or with regard to individual features. An exemplary embodiment can also be supplemented by features of a further exemplary embodiment.

1-10. (canceled)

11. An image capturing device for a vehicle, comprising:
a first image capturing apparatus configured to image a surrounding environment of the vehicle, situated outside a window of the vehicle, through a first region of the window, in a first image; and
a second image capturing apparatus configured to image a second region of the window in a second image, the first region and the second region of the window overlapping at least partly.

12. The image capturing device as recited in claim 11, wherein the first image capturing apparatus is configured to unsharply image the first region of the window in the first image, and wherein the second image capturing device is configured to sharply image the second region of the window in the second image.

13. The image capturing device as recited in claim 12, wherein the first image capturing apparatus and the second image capturing apparatus have a common image sensor for producing the first image and the second image.

14. The image capturing device as recited in claim 12, further comprising:
at least one optical element for deflecting at least one of (i) a first beam of light which is to be captured by the first image capturing apparatus for the imaging of the surrounding environment, and (ii) a second beam of the light which is to be captured by the second image capturing apparatus for the imaging of the second region of the window.

15. The image capturing device as recited in claim 14, wherein:
the at least one optical element includes a mirror, a first lens, and a second lens;
the first beam is guided through the first lens to the first image capturing apparatus; and
the second beam is guided via the mirror, the second lens, and the first lens to the second image capturing apparatus.

16. The image capturing device as recited in claim 12, further comprising:
an evaluation device configured to recognize, based on the second image, an impairment of view relating to the second region of the window.

17. The image capturing device as recited in claim 16, wherein the evaluation device is configured to recognize, based on the impairment of view, at least one of (i) a blind spot of the image capturing device and (ii) an impurity of the second region of the window.

18. The image capturing device as recited in claim 16, wherein the evaluation device is configured to evaluate the first image, taking into account the impairment of view relating to the second region.

19. The image capturing device as recited in claim 18, wherein:
the evaluation device is configured to determine a segment of the first image associated with the impairment of view; and
the evaluation device is configured to evaluate the first image while suppressing an item of information of the segment of the first image associated with the impairment of view.

20. The image capturing device as recited in claim 18, wherein the evaluation device is configured to recognize, based on the first image, at least one of (i) a blind spot of the image capturing device and (ii) an impurity of the first region of the window.
